(19) United States
(12) Patent Application Publication
(10) Pub. No.: US 2016/0341644 A1
(43) Pub. Date: Nov. 24, 2016

(54) MEASURING INSTRUMENT FOR DETERMINING THE DENSITY OF FLUIDS

(71) Applicant: ANTON PAAR GMBH, Graz-Strassgang (AT)

(72) Inventors: WOLFGANG BELITSCH, HART BEI GRAZ (AT); PATRICK TRUMMER, HART BEI GRAZ (AT); ROBERT BREIDLER, GRAZ (AT)

(21) Appl. No.: 15/160,396

(22) Filed: May 20, 2016

(30) Foreign Application Priority Data
May 20, 2015 (AT) A50409/2015

(51) Int. Cl. G01N 9/00

(52) U.S. Cl. CPC G01N 9/002

(57) ABSTRACT

A measuring instrument for studying fluid samples contains a flexural vibrator. A vibrator tube of which is fixed at at least one clamping position and forms on one side of the clamping position, in particular a carrier unit, a freely projecting vibrator section and on the other side a fluid feed tube section with a feed opening and a fluid discharge tube section with a fluid discharge opening. Accordingly, the vibrator tube is fixed or retained both at its fluid discharge tube section and at its fluid feed tube section with at least one independent holding device provided in addition to the clamping position.

### CROSS-REFERENCE TO RELATED APPLICATION

This application claims the priority, under 35 U.S.C. §119, of Austrian application A 50409/2015, filed May 20, 2015; the prior application is herewith incorporated by reference in its entirety.

### BACKGROUND OF THE INVENTION

### Field of the Invention

The invention relates to a measuring instrument for determining the density of fluids.

The principle of measuring the density of liquid or gaseous fluids with the aid of a vibrating glass tube, which is filled with the fluid to be measured, is known. The measurement of the density of fluid media with a flexural vibrator is based on the fact that the vibration of a hollow body filled with a sample to be studied is dependent on the filling of the vibrator tube, i.e. on the mass or, if the volume is constant, on the density of the medium with which it is filled.

The measurement cell of a measuring instrument contains as a vibratable structure a hollow vitreous or metallic vibrator tube, generally bent in a U-shape. This is electronically excited to vibrate. The two branches of the U-shaped tube form the spring elements of the vibrator. The natural frequency of the U-shaped vibrator tube is only influenced by that part of the sample which actually participates in the vibration. This volume V participating in the vibration is bounded by the stationary vibration nodes at the clamping positions of the vibrator tube. If the vibrator tube is filled with the sample at least as far as these clamping positions, the same accurately defined volume V always participates in the vibration, and the mass of the sample can therefore be assumed to be proportional to its density. Overfilling of the vibrator beyond the clamping positions is irrelevant for the measurement. For this reason, densities of fluids which flow through the vibrator can also be measured with the vibrator.

The density of the liquid thus determines the specific frequencies with which the U-shaped tube vibrates. If precision glass tubes or metal tubes are used, then their vibration properties vary according to the density and viscosity of the liquid. The resonant frequencies are evaluated by suitable excitation and decay of the vibrations, and the density of the fluid sample with which the tube is filled is determined from the period. The vibrator is adjusted with fluids of known density and the measurements can thus be evaluated.

The following generally applies for the period P and the density p:

$$ρ = {P}^{2} \frac{R}{4 {π}^{2} V} - \frac{m}{V} = A {P}^{2} - B \qquad ( 1 )$$

Such density vibrators or flexural vibrators are produced in a very wide variety of embodiments in terms of excitation and decay of the vibration. The excitation and decay of the resulting natural vibrations is carried out, for example, by solenoids and magnets, piezoelectric elements, capacitive sampling, etc. Distinction is made between different forms of flexural vibrators according to the nature of the excited vibration.

Y-vibrators consist of a tube bent in a U-shape with parallel branches and vibrate perpendicularly to the plane formed by the two branches of the vibrator. In this case, a relatively large counterweight is needed in order to ensure that the vibration is determined purely by the spring/mass system consisting of the U-tube and the sample.

So-called X-vibrators, in which the branches of the U-tube vibrate symmetrically counter to one another, do not require any counterweight since in this case the error influences are eliminated by the symmetrical vibration pattern. In this case, on the one hand, vibrators with two branches having a bend similar to a U-tube are known, but on the other hand also so-called double-bow vibrators in which two parallel U-tubes vibrate counter to one another.

In principle, such vibrators may be made of metal and glass. However, glass vibrators are preferred in this case because of their high resistance to aggressive media, for example solvents, acids, bases, etc. At the same time, the filling in such glass vibrators can also be monitored and/or detected visually with the naked eye and/or a camera.

In the general case, such vibrators are also enclosed by a glass housing and configured as a measurement cell, which housing protects the vibrator from ambient influences. In order to establish good thermal contact with a thermal regulation unit, these measurement cells are for example filled with hydrogen.

The glass tube is usually filled with the fluid to be measured by a syringe or an automatic sample filling unit, or flowed through by it, the fluid being introduced into the glass tube with the syringe at an inlet opening through a plastic bush, flowing through the vibrator and in turn flowing out through a plastic bush at the outlet opening. The plastic bushes are in this case fastened either on the vibrator housing or on the carrier of the housing, this being done for example by screws or clamps of the bushes. The bushes are of course applied in such a way that they do not extend into the vibrator volume contributing to the measurement. Preferred bush materials are durable plastics, for example PTFE (polytetrafluoroethylene), FEP (perfluoroethylene-propylene).

Since the junction between the plastic bush and the glass tube must be airtight, the plastic bushes are pressed against the glass tube with a relatively large force, which leads to mechanical stresses in the glass tube. It has been possible to demonstrate that these stresses influence the resonant frequency of the glass tube and therefore have a detrimental effect on the accuracy of the density measurement, above all when a large syringe (for example 10 ml) is fitted directly onto the plastic bushes or the temperature of the measurement cell is modified, since even very minor length changes in the vibrator in the manner of a clamped spring lead to a change in the natural frequency.

Accurate study of vibrators during the measurement shows that even the fitting of the bushes leads to different loads and is highly user-dependent. Images of the vibrator under polarized light show that the glass bars which carry the vibrator, or connect it to the surrounding instrument housing and therefore also to the counterweight, are not uniformly loaded by the pressure of the connecting bushes, which leads to mechanical stresses in the glass body in the connecting region between the vibrator and the housing. These stresses have a direct influence on the natural frequency of the vibrator and lead to inaccuracies in the vibration behavior.

In the event of a change of the measurement temperature, the variation of the stress in the glass because of the varying application pressure due to the bushes leads to inaccuracies in the natural frequency or damping, and therefore also to errors in the measured density, or viscosity correction. It may sometimes even be necessary to readjust the instrument by measuring standards.

This also applies for the thermal regulation of the vibrator, which is required for a temperature-dependent measurement. In this case as well, these stresses lead to slower reaching of the stable measurement values, and the hysteresis of the glass when passing through temperature curve ramps also leads to inaccuracies in the natural frequency or damping, and therefore also in the measured density, or viscosity correction.

In the worst case, particularly for high-accuracy measurements to the 6th decimal place, i.e. +−10 E-6 g/cm³, the vibrator therefore needs to be readjusted by measurement with standards after passing through temperature curves.

These effects due to mechanical stresses in the glass were hitherto entirely unknown, and have been demonstrated by high-accuracy polarization images of the vibrator while carrying out the tests by measurements of repeatability.

In order to reduce these stresses, for example, the vibrator could be fastened more stably on the housing or the vibrator tubes could be strengthened in the filling region. This, however, is limited by the cooling behavior of the glasses because the vibrators could break because of the stresses occurring during cooling.

### SUMMARY OF THE INVENTION

According to the invention, a measuring instrument of the type mentioned in the introduction is characterized in that the vibrator tube is fixed or retained both at its fluid discharge tube section and at its fluid feed tube section with at least one independent holding device provided in addition to the clamping position. In particular, by virtue of an additional holding bar, the flexural vibrator can be mechanically decoupled from the connection or clamping position and both the flexural vibrator and a reference vibrator can therefore be protected from excessively high stresses. The primary aim of the invention, to minimize or suppress the connection effect of bushes on a glass vibrator and therefore improve the accuracy of the measurement, is therefore achieved. Furthermore, the problem of the behavior of the measurement cell because of stresses occurring after a temperature change of the measurement cell is resolved.

All known devices for clamping and holding vibrator tubes may be used as a clamping position.

The invention therefore provides additional stiffening means at a particular position of the vibrator tube. The purpose of the stiffening means is to absorb the forces introduced onto the vibrator tube via the bush from a feed unit, in particular a syringe, and preferably to dissipate them to the measuring instrument housing. It is to be noted that the stiffening means is not the same as any bar that is provided, which carries a reference vibrator. The stiffening means, or the holding bar, may also be used as a connecting bar between the sections of the vibrator tube in the feed or discharge region. The precise position and orientation, i.e. a straight or oblique profile with respect to the vibrator tube, of the stiffening means or holding device may vary. However, the stiffening means lies principally in the region between the bush connection and the clamping position of the vibrator tube.

It is in principle possible for the reference vibrator to be connected not directly to the bar carrying the vibrator tube, or for it to be connected to this bar, but not too close to the housing. Because of the pressing of the bushes into the body of the reference vibrator, however, mechanical stresses which have a detrimental effect on the vibration behavior of the reference vibrator are also generated on these bars carrying the vibrator tube, or the reference vibrator. With the holding device provided according to the invention, however, such stresses are also minimized.

Any connection, preferably a flexurally stiff connection, between a sleeve tube or housing of the flexural vibrator or measuring instrument housing and the two fluid connection sections of the vibrator tube is suitable as a holding device.

Everything which lies on the bush side of the clamping position or of the clamping bar of the vibrator tube is to be regarded as infinitely stiff in relation to the vibrator; stresses occurring there are minimized according to the invention.

The invention is particularly advantageous when, in addition to the flexural vibrator, a reference vibrator is provided, since the latter profits from the stiffening means provided for the vibrator tube of the flexural vibrator by the holding device, and can likewise be operated more precisely. It is possible to secure the reference vibrator on a glass frame of the measuring instrument or to arrange it on the vibrator tube or on the carrier or bar carrying the latter.

The reference vibrator may be formed by a U-tube or a simple glass rod, in order in particular to correct the ageing behavior and the thermal hysteresis of the glass used. In any case, the undesired effects of the connection of bushes can be excluded.

In preferred cases, the reference vibrator may be excited to vibrate with the same exciter system as the measurement vibrator, or the vibrator tube. This allows simple manufacture with fewer parts.

A structure of the measuring instrument which is simple in design terms is obtained when the holding device is formed by at least one holding bar or holding tube fastened on the housing and/or frame of the measuring instrument and on the fluid feed tube section and/or on the fluid discharge tube section.

When provision is made that the vibrator tube is fixed at two clamping positions, in particular carrier units, and optionally connected between them to a vibration excitation unit, it is advantageous for the holding device to be connected to the fluid feed tube section and fluid discharge tube section of the vibrator tube outside the section of the vibrator tube bounded by the clamping positions.

In practice, it is advantageous that the vibrator tube carries a reference flexural vibrator or the clamping positions, preferably formed by carriers, of the reference vibrator, in the extent of said vibrator tube between its two clamping positions.

A stable structure and good holding, or vibration damping and avoidance of stresses, is achieved when the holding device or the holding bar, or the holding tube, is connected on both sides of the vibrator tube to the housing and/or frame of the measuring instrument at positions opposite one another with respect to the vibrator tube, and/or when the holding device or holding bar encloses the vibrator tube in the region of the fluid feed tube section and the fluid discharge tube section, advantageously on all sides or over this entire circumference, or these two sections pass through the holding bar and are connected thereto with a fixed position.

The invention is particularly advantageous when provision is made that bushes for connecting a fluid feed and discharge are connected to the fluid feed tube section and to the fluid discharge tube section, or to the vibrator tube on the fluid feed side and fluid discharge side of the clamping position, and/or that the vibrator tube and/or the holding device or the holding bar and/or a carrier forming the clamping position consist of glass.

According to a preferred embodiment, it is provided that the bushes connected to the fluid feed tube section and the fluid discharge tube section of the vibrator tube are connected by a holder to the housing and/or frame.

It is entirely possible for the holding device to contain a holding bar for the fluid feed tube section and a holding bar for the fluid discharge tube section, which connect the respective tube section to the housing and/or the frame and fix them immovably in position.

Other features which are considered as characteristic for the invention are set forth in the appended claims.

Although the invention is illustrated and described herein as embodied in a measuring instrument for determining the density of fluids, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a section of a measuring instrument according to the invention;

FIGS. 2A and 2B are illustrations showing two different embodiments of measuring probes; and

FIGS. 3A and 3B are schematic embodiments of measuring instruments according to the invention.

### DETAILED DESCRIPTION OF THE INVENTION

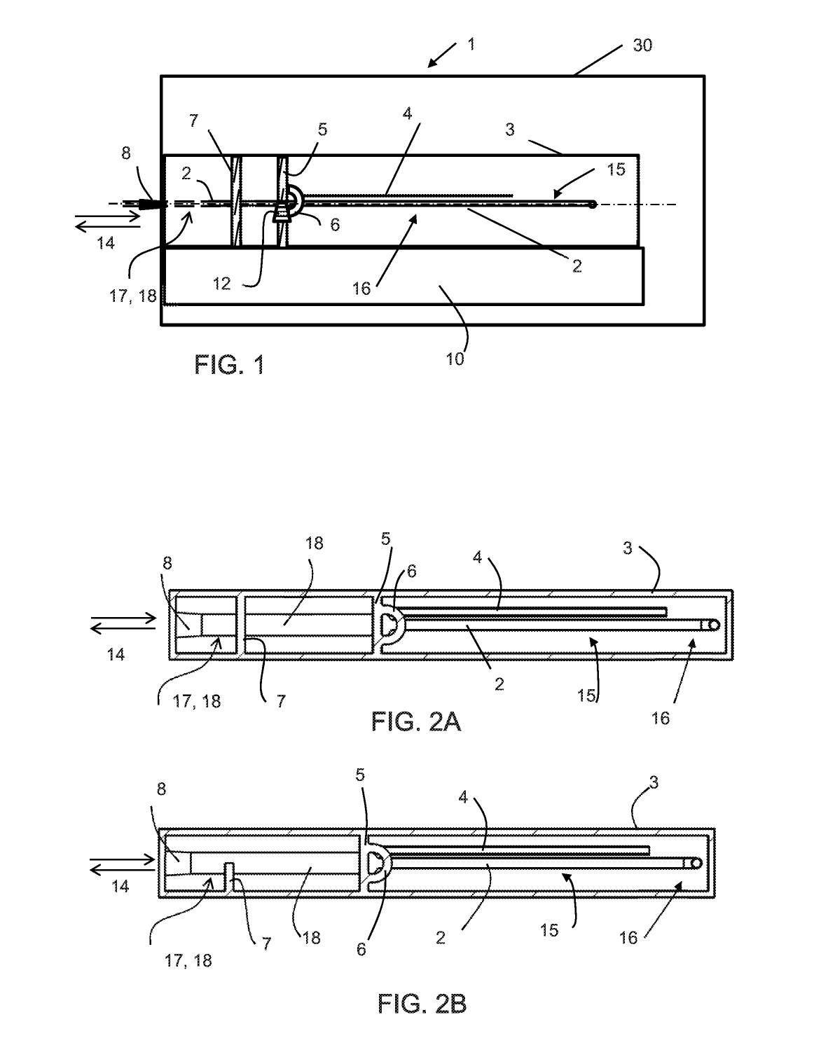

Referring now to the figures of the drawings in detail and first, particularly to FIG. 1 thereof, there is shown a measuring instrument 1, which is arranged inside a thermal regulation chamber 30 and contain a measuring instrument housing 3 which is arranged on a frame 10, which frame 10 is also used as a counterweight or for thermal regulation of the sensor housing. On the frame 10, or inside the measuring instrument housing 3, or connected to the latter, there is a carrier which forms a clamping position 5 for a vibrator tube 2 of a flexural vibrator. The vibrator tube 2 fixed at the clamping position 5 can be excited to vibrate in its freely projecting vibrator section 16 by a vibration excitation unit 12. A clamping position 5 of the vibrator tube 2 of a flexural vibrator 15 holds the latter firmly, the sections of the vibrator tube 2 which are used for the fluid feed and fluid discharge into and out of the vibrator tube 2 respectively being located on the opposite side of the clamping position 5 from the vibrator section 16. A fluid feed tube section 17 and a fluid discharge tube section 18 are fixed, or held so they cannot vibrate, by a holding device 7, in the present case a bar, provided in addition to the clamping position 5. The holding device 7 is connected to the measuring instrument housing 3 and/or to the frame 10. Bushes 8, with which the fluid to be studied can be fed to the flexural vibrator 15, and discharged therefrom, according to the arrows 14 are respectively connected to the fluid feed tube section 17 and to the fluid discharge tube section 18.

The bushes 8 are placed on the vibrator tube 2, preferably in a fluid-tight fashion, or fastened thereon, and connected thereto in a fluid-tight fashion.

The holding device 7 may be configured in the form of a bar which is round or polygonal or has a different profile; the holding device 7 may also be formed by a tube.

The carrier forming the clamping position 5 may also carry a carrier 6, by which a reference flexural vibrator 4 is carried.

FIGS. 2A and 2B show in section a flexural vibrator similar to one in practice. The bent carrier 6 carries a reference vibrator 4 and extends from the carrier of the clamping position 5 of the vibrator tube 2 of the flexural vibrator 15.

As can be seen from FIG. 1, the vibrational excitation is carried out with a schematically represented vibration excitation unit 12 in the region in front of the clamping position 5 in the freely projecting vibrator section 16.

It can be seen from FIGS. 2A and 2B that in this embodiment the holding device 7 is formed by a bar which connects the fluid discharge tube section 18, which has a larger diameter than the freely projecting vibrator section 16, of the vibrator tube 2 to the housing 3. The fluid feed tube section 17 is fixed in the same way.

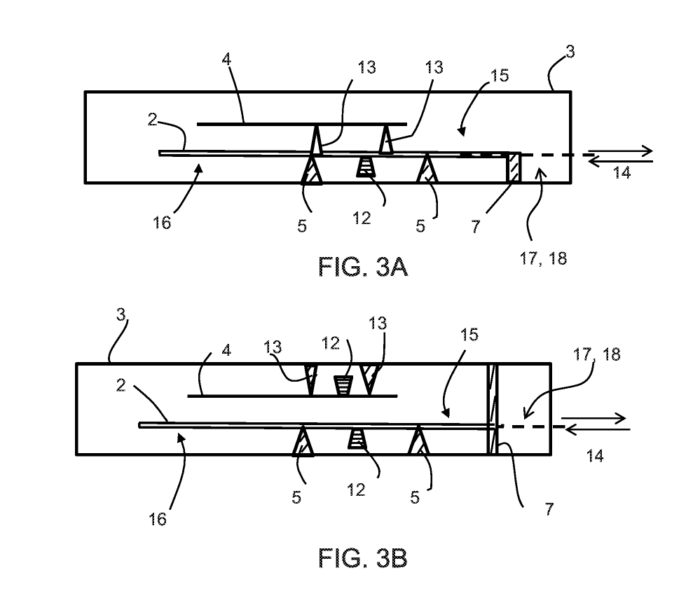

When the vibrator tube 2 is fixed at two clamping positions 5, as is represented in FIGS. 3A and 3B, the vibration excitation unit 12 may lie between the two clamping positions 5. The clamping positions 13 of a reference vibrator 4 placed directly on the vibrator tube 2 of the flexural vibrator 15 lie between the two clamping positions 5 of the vibrator tube 2. In the fluid feed tube section 17 and in the fluid discharge tube section 18, the vibrator tube 2 is fixed by the holding device 7, which according to FIGS. 3A-3B extends from the wall of the measuring instrument housing to the vibrator tube 2.

In the embodiment according to FIG. 3B, the two clamping positions 13 of the reference vibrator 4 lie on the wall of the housing 3.

As can be seen from FIG. 2A, the fluid feed tube section 17 and the fluid discharge tube section 18 may be fed through the holding bar of the holding device 7, and thereby retained.

Above all, the use of the invention is advantageous when the vibrator tube 2 and the holding device 7 are formed from glass, since in this case attack by aggressive media is avoided.

Lastly, it is also possible to connect the bushes 8 to the housing 3 of the measuring instrument 1 in order to mount the bushes 8 substantially without the possibility of movement for the measurement.

1. A measuring instrument for studying fluid samples, comprising:
at least one independent holding device;
at least one device defining a clamping position; and
a flexural vibrator having a vibrator tube being fixed at said clamping position and forms on one side of said clamping position a freely projecting vibrator section and on another side a fluid feed tube section with a feed opening formed therein and a fluid discharge tube section with a fluid discharge opening formed therein, said vibrator tube is fixed or retained both at said fluid discharge tube section and at said fluid feed tube section by said independent holding device in addition to said clamping position.

2. The measuring instrument according to claim 1,
further comprising a housing;
further comprising a frame; and
wherein said independent holding device is formed by at least one holding bar or holding tube fastened on at least one of said housing or said frame and on at least one of said fluid feed tube section or on said fluid discharge tube section.

3. The measuring instrument according to claim 2, wherein:
said device is one of two devices defining two clamping positions, said vibrator tube is fixed at said two clamping positions; and
said independent holding device is connected to said fluid feed tube section and said fluid discharge tube section of said vibrator tube outside a section of said vibrator tube bounded by the clamping positions.

4. The measuring instrument according to claim 1, further comprising a reference flexural vibrator carried by said vibrator tube.

5. The measuring instrument according to claim 2, wherein said independent holding device, said holding bar, or said holding tube is connected on both sides of said vibrator tube to at least one of said housing or said frame at positions opposite one another with respect to said vibrator tube.

6. The measuring instrument according to claim 1, further comprising brushes connected to said fluid feed tube section and to said fluid discharge tube section.

7. The measuring instrument according to claim 2, wherein said independent holding device or said holding bar encloses said vibrator tube in a region of said fluid feed tube section and in a region of said fluid discharge tube section, on all sides or over an entire circumference.

8. The measuring instrument according to claim 1, wherein at least one of said vibrator tube or said holding device is formed from glass.

9. The measuring instrument according to claim 6, further comprising:
a housing;
a frame; and
a holder, said bushes connected to said fluid feed tube section and said fluid discharge tube section of said vibrator tube are connected by said holder to at least one of said housing or said frame.

10. The measuring instrument according to claim 1,
further comprising a housing;
further comprising a frame; and
wherein said independent holding device has a first holding bar for said fluid feed tube section and a second holding bar for said fluid discharge tube section, and connects a respective one of said fluid feed tube section and said fluid discharge tube section to at least one of said housing or said frame and fix them immovably in position.

11. The measuring instrument as claimed in claim 1, wherein said freely projecting vibrator section is a carrier unit.

12. The measuring instrument according to claim 3,
further comprising a vibration excitation unit;
wherein said vibrator tube is fixed at said two clamping positions and connected between said two clamping positions to said vibration excitation unit; and
said independent holding device is connected to said fluid feed tube section and said fluid discharge tube section of said vibrator tube outside a section of said vibrator tube bounded by said two clamping positions.

13. The measuring instrument according to claim 3, further comprising:
a reference flexural vibrator;
two further devices defining two further clamping positions, said vibrator tube carrying said two further devices in an extent of said vibrator tube between said two clamping positions.

14. The measuring instrument according to claim 13, wherein said two further devices are carriers.

15. The measuring instrument according to claim 1, further comprising brushes connected to said vibrator tube on a fluid feed side and to a fluid discharge side of said clamping position respectively.

16. The measuring instrument according to claim 2, wherein said fluid feed tube section and said fluid discharge tube section pass through said holding bar and are connected to said holding bar at a fixed position.

17. The measuring instrument according to claim 2, wherein:
said device is a carrier; and
at least one of said holding bar or said carrier is formed of glass.
